(19) United States
(12) Patent Application Publication
(10) Pub. No.: US 2012/0164521 A1
(43) Pub. Date: Jun. 28, 2012

(54) Galvanic Cell

(75) Inventors: Guenter Eichinger, Altenstadt (DE); Juergen Hofmann, Kamenz (DE); Joerg Breu, Kamenz (DE)

(73) Assignee: LI-TEC BATTERY GMBH, Kamenz (DE)

(21) Appl. No.: 13/202,813

(22) PCT Filed: Dec. 16, 2009
(86) PCT No.: PCT/EP2009/009031

§ 371 Date: Feb. 15, 2012

(30) Foreign Application Priority Data
Feb. 23, 2009 (DE) 10 2009 010 147.0

(51) Int. Cl. H01M 2/30; H01G 9/04

(52) U.S. Cl. 429/179; 361/500

(57) ABSTRACT

Conductors of a galvanic cell with an essentially flat housing are accessible from the outside by means of recesses, shaped as window-like openings which are essentially arranged in a plane and in parallel to the flat housing surface of the cell.

Priority application DE 10 2009 010 147 as filed on Feb. 23, 2009 is fully incorporated by reference herein.

The present invention relates to a galvanic cell. Galvanic cells are required and used for different applications in different fields of technology. For most of these applications, it is important, besides other objectives, to maximize the energy density per volume, i.e. the stored energy per volume of the galvanic cell. Galvanic cells are suitable for the building up batteries out of a plurality of such cells. Therefore, such cells are sometimes also referred to as battery cells.

Galvanic cells with a flat- or a rectangular-shape are known, whose electrochemically active content, usually a so-called film stack, is surrounded by a mostly two-part film-like packaging, through which electrical contacts protrude in form of metal sheets (“conductors” or “conductor sheets”). The film is often composed of an aluminum foil, which is coated on both sides with an electrically-insulating plastic. Battery cells constructed this way are often referred to as pouch cells or coffee-bag cells. The electrical voltage is often redirected by contact elements, which are contacted to the conductor sheets by form-fit, force-fit or by material engagement. Said contact elements may be contacted to the conductors on one or on two sides. For single cells, the contact elements are directly or indirectly in contact with the electric power users or, respectively, with power sources. For batteries or cell blocks, the contact elements are used for electrical circuit formation of the cells in series or in parallel.

An important distinguishing feature of such cells compared to other cell types is, that the packaging is not at a certain electrical potential but, instead, electrically neutral. The conductors protrude through the packaging in an insulated manner.

In light of the objective to maximize the energy density per volume, it is often disadvantageous, when the lateral (“radial”, i.e. aligned in parallel to the surface area of the cell packaging) protrusion of the conductors through the packaging, leads to a loss of useable construction space due to welding areas/points.

The present invention has the objective to contribute to maximizing the energy efficiency per volume of such galvanic cells. Said objective is achieved by a galvanic cell according to claim 1.

For this galvanic cell according to the invention, with an essentially flat housing and at least two electrical conductors of opposite electrical polarity for dissipation of the energy that is stored in the galvanic cell, the conductors or the housing, is/are configured such that the conductors are accessible from the outside for electrical contacts by means of recesses of the housing, which are shaped as window-like openings and which are essentially arranged in planes and in parallel to the flat housing surface of the cell.

A galvanic cell according to the invention refers to all types of electrical cells, in particular, also capacitors or electrochemical cells, and in case of the latter, in particular, primary and/or secondary cells. At least two connection elements or electrodes which generally are also referred to by the person skilled in the art as conductors or conductor sheets protrude through the housing of such galvanic cells, and are used to discharge the energy stored in the galvanic cell. Said conductors often only protrude through a few sites of the housing.

A recess of the housing, which is shaped as a window-like opening and which is essentially arranged in a plane and in parallel to the flat housing surface of the cell refers, in this context, to any structure, which makes the conductors accessible for contacting the same from a flat side of the cell. Preferably, said structures are configured such that the conductors are protected by the narrow edges of the housing, based on the insulating properties of the housing material, against, for example, a non-intended contacting.

Advantageous embodiments of the invention are the subject-matter of the dependent claims. In the following, the invention is further described, based on preferred embodiments and with the aid of figures.

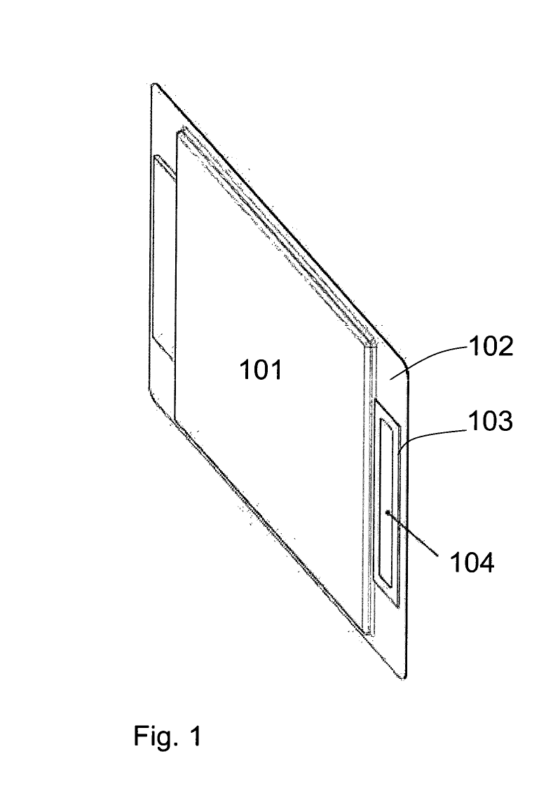

FIG. 1 shows a flat galvanic cell according to a first example of the present invention;

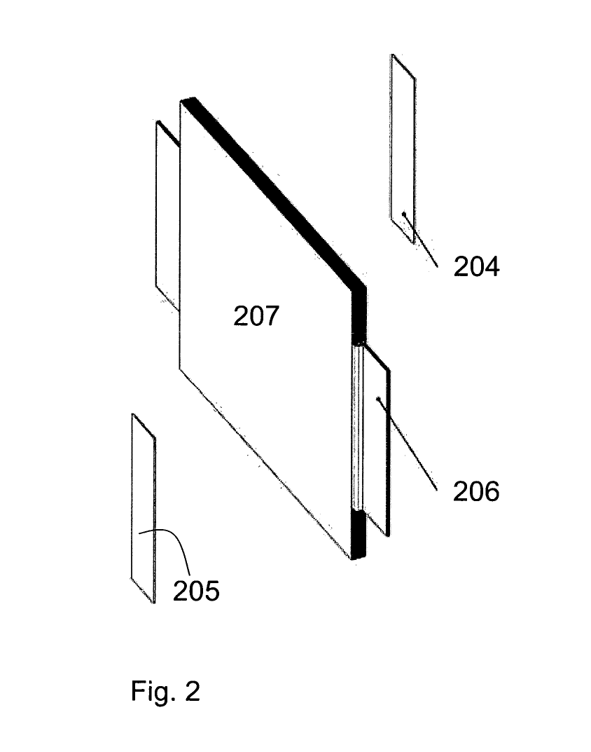

FIG. 2 shows an exploded view of the film stack of a galvanic cell according to the first example of the present invention;

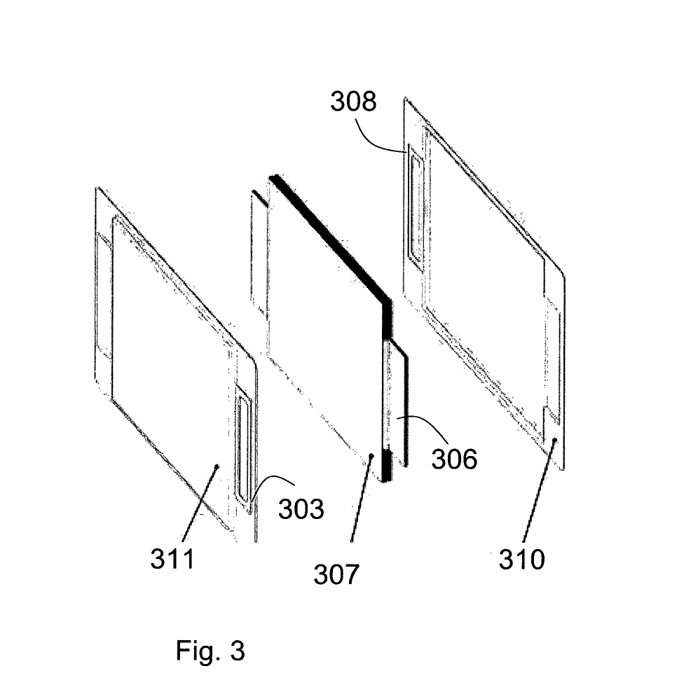

FIG. 3 shows an exploded view of the galvanic cell according to the first example of the present invention;

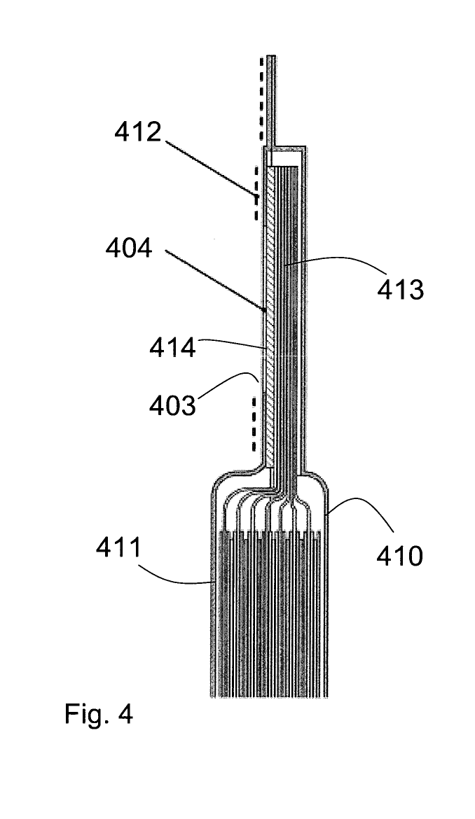

FIG. 4 shows a partial view of a section through a cell according to the first example of the present invention;

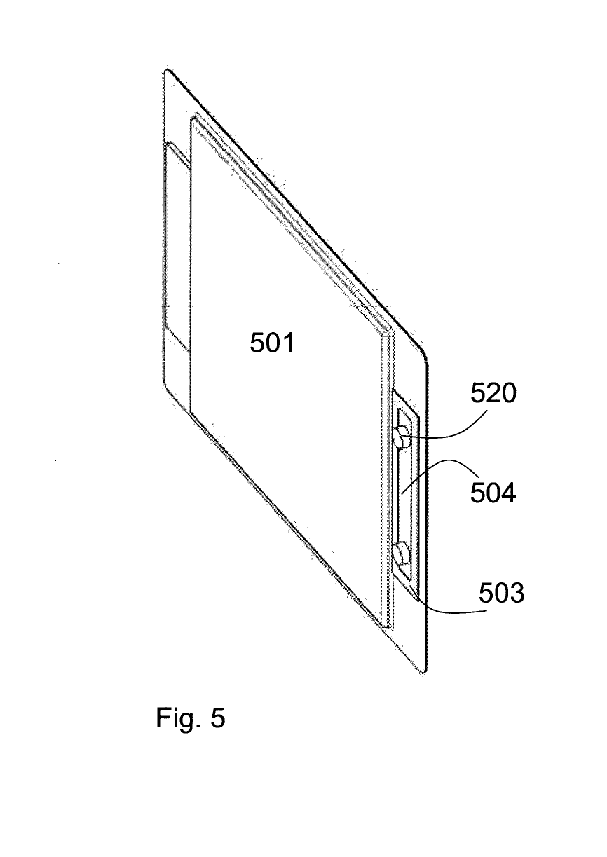

FIG. 5 shows a view of a second example of the present invention;

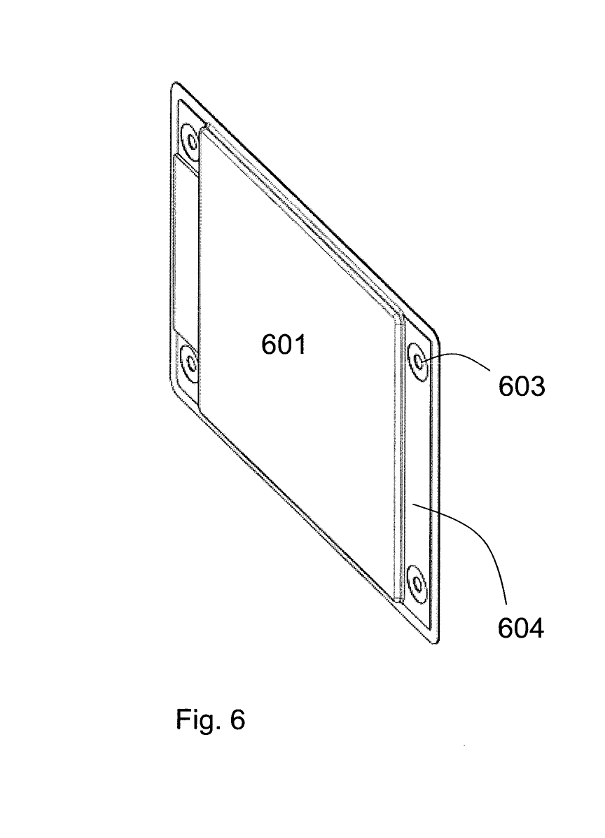

FIG. 6 shows a view of a third example of the present invention;

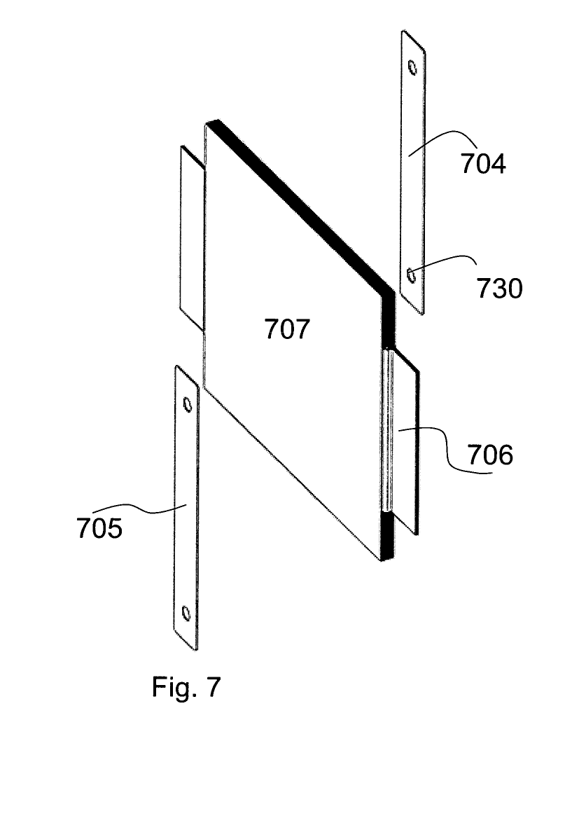

FIG. 7 shows an exploded view of the film stack of a galvanic cell according to the third example of the present invention;

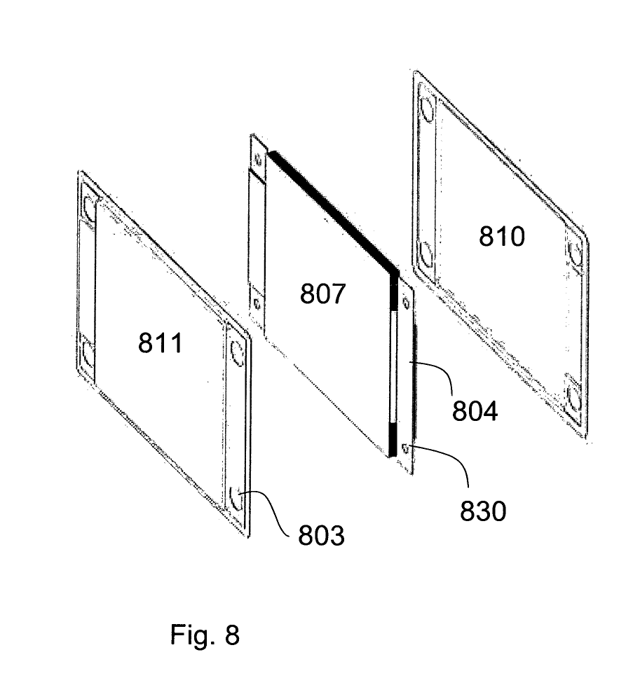

FIG. 8 shows an exploded view of the galvanic cell according to the third example of the present invention;

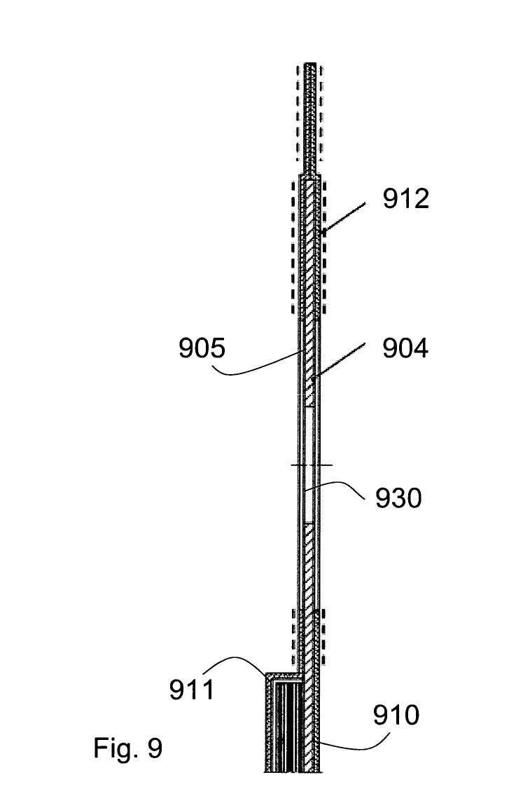

FIG. 9 shows a partial view of a section through a cell according to the third example of the present invention;

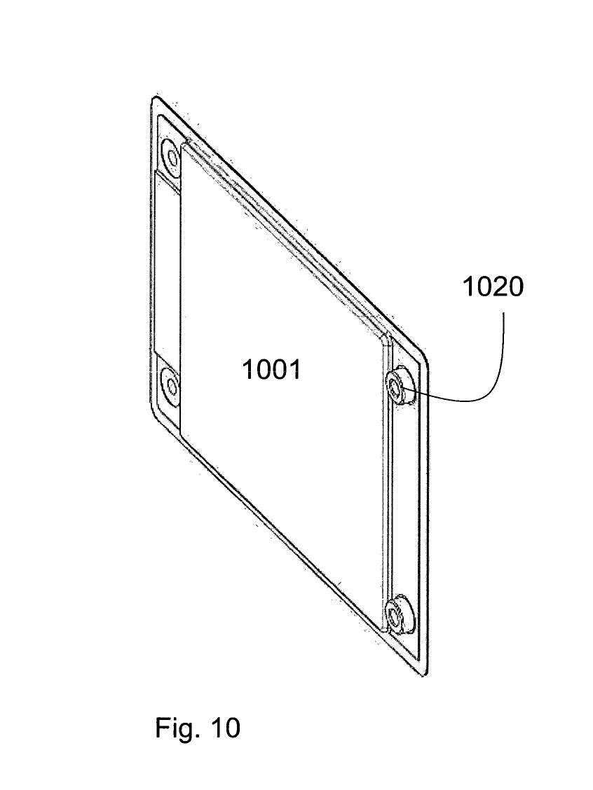

FIG. 10 shows a view of a fourth example of the present invention;

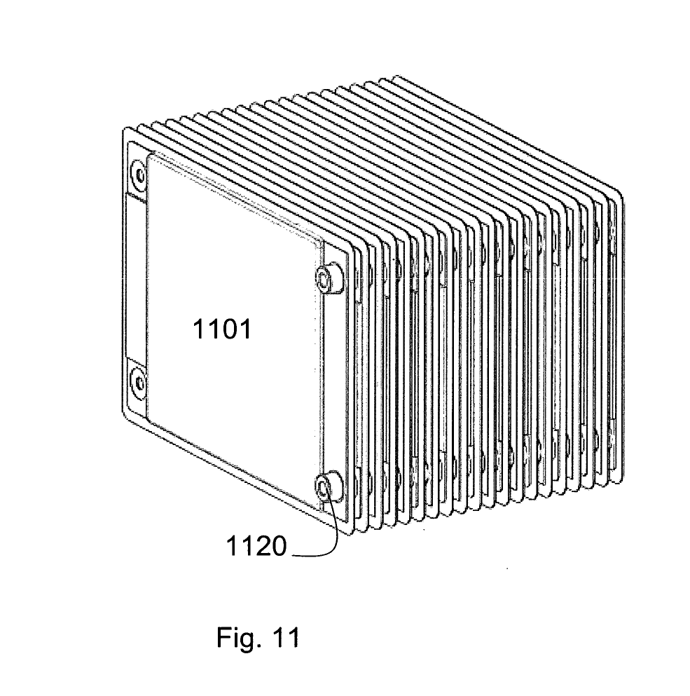

FIG. 11 shows a view of a cell block of cells according to the fourth example of the present invention.

As is shown in FIG. 1, conductors 104 of a cell 101 do not protrude through the sides of the insulating packaging 102 but are accessible from the outside by means of a recess 103 in the packaging, which is shaped as a window-like opening. It is also possible, that the conductors are enclosed by a portion of the packaging and sealed into said packaging. The conductors 104 are exposed by means of the recess 103 of the packaging film 102, which is shaped as a window-like opening. For these and other embodiments of the invention, the conductors can be designed as a flat metal sheet or they can be provided with additional contact sleeves 520 or strips, as shown in FIG. 5 for another embodiment of the invention. These additional contact sleeves or strips may bridge, for example, the distance to the next cell of a cell block.

When the windows are arranged, preferably, in an area outside of a welding zone, between a conductor and the ends of the electrode stack (anode and cathode foils), the conductor may be exposed on the front and the back side of the cell. This facilitates the contacting and fixation of the cells, since in this case, holes for anchor rods and similar means for the building up of a cell block of a plurality of galvanic cells may be introduced through the conductor.

FIGS. 1 to 5 show a first exemplary embodiment of the present invention, in which the conductors are accessible from one side (from the top or from the bottom) of the cell, respectively. FIGS. 6 to 10 show another exemplary embodiment of the invention, in which the packaging is provided with windows at the top and at the bottom within the area of the ends of the conductor, and the conductors are accessible from both sides. The cells according to this embodiment of the invention are particularly well suited to be mechanically fixated to the conductors, for example, during the assembly of a cell block, since they are completely within the packaging of the cell and therefore, they are stress-resistant, as particularly shown in FIG. 11.

FIG. 2 shows an exploded view of the film stack of a galvanic cell according to the exemplary embodiment of the invention shown in FIG. 1. Electrodes 206 of the electrode stack 207 protrude in the known manner to the outside on the ends of the electrode stack. In this example, conductor sheets 204, 205 are applied onto the electrodes for mechanical stabilization.

FIG. 3 shows the assembly of a cell of this embodiment with the addition of the upper and the lower housing parts, or, respectively, the packaging parts. The lower housing part 310 has a recess 308, shaped as window-like opening, and the upper housing part 311 has a corresponding recess 303, shaped as window-like opening, on the other end of the electrode stack, by means of which the conductor 306 and hence, the electrodes 306 of the electrode stack 307, which are electrically connected to it, are electrically accessible from the outside, namely through the recess 303 shaped as window-like opening.

FIG. 4 shows a partial view of a section through a cell according to the exemplary embodiment of the invention illustrated in FIGS. 1 to 3. Between the lower part 410 of the packaging (housing) and the upper part 411 of the packaging, the cell is almost completely sealed 412 together with the conductor. The conductor sheet is accessible from the outside only by means of the openings 404 in the recess 303 of the housing, which is shaped as window-like opening.

FIG. 5 illustrates as a second exemplary embodiment of the invention, a variant of the first embodiment, in which at least a conductor 504 is provided with structural elements 520, to support its contacting. These structural elements extend, to a non-negligible extent, in a direction perpendicular to the planes, which are in parallel to the flat housing surface of the cell. In lieu of the protrusions or contact sleeves 520, which are shown in FIG. 5, respectively structured strips or other structures can also fulfill the same purpose.

FIG. 6 shows a third exemplary embodiment of the invention, in which the packaging is provided with windows on the upper and on the lower area of the conductor ends, and in which the conductors are accessible from both sides. The conductors are provided with through-holes 603, which can be used for the mechanical fixation of the cells to the conductors, when assembling a cell block.

FIG. 7 shows a corresponding exploded view of this exemplary embodiment of the invention with a cell stack 707, with electrodes protruding through the stack 706, with corresponding conductor sheets 704, 705 and in this case, with round through-holes 730 within the conductor sheets.

FIG. 8 shows a corresponding exploded view with the lower 810 and the upper 811 housing parts, which are also provided with corresponding through-holes 803, through which the conductor sheets 804 of the electrode stack 807 with their through-holes 830 are electrically accessible from the outside.

A corresponding cross section of such a cell is shown in FIG. 9. Similar to other embodiments of the invention, in this case, the electrode stack, together with the conductor sheets 904, is almost completely sealed by the lower 910 and by the upper 911 packaging parts. This seal 912 is only broken in the area of the recess 905 of the packaging, which is shaped as a window-like opening, through which the conductor sheets 904 with its through-holes 930 is accessible from the outside.

This embodiment can also be realizable—as shown in FIG. 10—in a variant, in which the conductor sheets of the cell 1001 are provided with additional structural elements 1020, which support a contacting of the conductor sheets. Said structural elements are, preferably, also contact sleeves or protrusions or strips, or similar structures, which extend to a non-negligible extent to a direction perpendicular to the planes, which are in parallel to the flat housing surface of the cell.

FIG. 11 shows a view of a cell block of cells according to this exemplary embodiment of the invention, in which the additional structures of the conductor sheets have the shape of extended poles. The fixture of the cells to form a mechanically stable block and to form an electrical circuit in series, is, preferably, accomplished by anchor rods, which are not illustrated in this figure.

Various embodiments of the invention can also be combined with each other, as it is immediately obvious from the present description to the person skilled in the art.

1-4. (canceled)

5. A galvanic cell (101, 501, 601, 1001) comprising an essentially flat housing (102) and at least two electrical conductors (104, 204, 205, 306, 414, 504) of opposite electrical polarity for the discharge of energy, which is stored in the galvanic cell, wherein the conductors or the housing are configured such, that the conductors are accessible from the outside for electrical contact by means of recesses (103, 303, 308, 403, 503, 904) of the housing, which are shaped as window-like openings and which are arranged on both sides (910, 911) of the flat housing and which are arranged essentially in planes and in parallel to the flat housing surface of the cell,
wherein
at least one conductor (504, 604, 704, 705, 804, 905)is provided with structural elements (520, 604, 730, 830, 930, 1020, 1120) to support contacting the same, which extends to a non-negligible extent in a direction perpendicular to the planes, which are in parallel to the flat housing surface of the cell,
wherein
said structural elements are provided so that they can bridge the distance to the next cell of a block of cells.

6. The galvanic cell (1001, 1101) according to claim 1, with conductors (704, 705) or a housing, which comprise holes (730, 803, 830) for the insertion of anchor rods or similar components for the assembly of a battery of a plurality of cells.
